(19) United States
(12) Patent Application Publication
(10) Pub. No.: US 2006/0150518 A1
(43) Pub. Date: Jul. 13, 2006

(54) Support for a sliding panel

(75) Inventors: Adrianus Jacob Van 't Zelfde, Ridderkerk (NL); Christianus Wilfred Michael Slobbe, Tilburg (NL)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Hunter Douglas Industries BV, EL Rotterdam (NL)

(21) Appl. No.: 11/313,349

(22) Filed: Dec. 21, 2005

(30) Foreign Application Priority Data
Jan. 7, 2005 (EP) 05075027.2

(51) Int. Cl. E05D 15/06

(52) U.S. Cl. 49/409

(57) ABSTRACT

A sliding panel for use in an architectural opening is connected either at its top edge or bottom edge to a carrier that supports the panel with a magnetic system that includes a magnet and a ferrous member. The magnet is positioned on either the carrier or the panel and the ferrous member is on the other of the carrier or the panel with the magnet attracting the ferrous member to connect the panel to the carrier.

### CROSS REFERENCE TO RELATED APPLICATION

This application claims priority to European patent application No. 05075027.2, filed 07 Jan. 2005, which is hereby incorporated by reference as if fully disclosed herein.

### BACKGROUND OF THE INVENTION

1. Field of the Invention

The invention relates to a sliding panel, such as a vertical venetian blind panel, a wall hanging, a solid door or a screen door, which is releasably connected, at its top or upper edge or at its bottom or lower edge, to a carrier that can slide or roll smoothly and easily along a track that supports the panel.

2. Description of the Related Art

Sliding panels are known, for example from GB 2 001 120, U.S. Pat. No. 3,261,129 and U.S. Pat. No. 3,925,933. A sliding door generally is provided at its top or upper edge with moving means such as wheels, rollers, runners, sliding blocks or the like that can slide or roll along a track. The sliding door with its moving means depends from a track that is usually part of a profile, attached to a fixed surface, such as a ceiling, which is near or parallel to a door frame. Generally, the moving means and the door are interconnected by a carrier. The carrier can be C-shaped, L-shaped or even U-shaped. The C- and L-shaped carriers usually include: on a top leg, a flange with a hole or opening, to which the moving means is attached; and on a bottom leg or on a bottom portion of a vertical leg, an opening, to which the top of the door is attached.

Generally bolts are used to connect a carrier to moving means and to a sliding panel. For example, in EP 0 487 956, a bolt (25) through a slot (23) attaches a carrier (3), which includes rollers as moving means, to a panel (1). An advantage of this connection of bolt and slot is that the height of the panel can be adjusted without disconnecting the panel from the carrier. The panel cannot be easily disconnected from the carrier.

However, it is often desirable to have an easily releasable connection between the carrier and its sliding panel. For example, because a screen door is very useful in periods of warm weather but not in cooler periods, it is often desirable to be able to easily mount and dismount the screen door.

An easily releasable connection to a sliding panel, described in DE 199 46 170, involves a plurality of snap connections (8). However, such snap connections (8) have to be turned in order to release the panel. This means that a tool must be used, and each snap connection must be turned in order to release the panel. This makes the releasability less convenient than desired.

The easily releasable connection described above is of use only in a type of vertical blind with sliding blind panels as described in DE 199 46 170. Such panels are lighter in weight than sliding doors. A snap connection that is strong enough to securely hold a door which is significantly heavier in weight than a light blind panel would have to be quite strong and thus will be difficult to release.

### SUMMARY OF THE INVENTION

In accordance with this invention, a sliding panel is provided which is releasably connected at its top or upper edge and/or at its bottom or lower edge to a carrier that supports the panel; wherein the means for releasably connecting the panel and the carrier comprises a magnet and a ferrous member which is attracted to, and can be magnetically attached to, the magnet; and wherein the magnet is on one of either the carrier or the panel and the ferrous member is on the other of the carrier or panel. This connection makes it easier to connect and to release the panel from the carrier, while at the same time not allowing Inadvertent release of the panel from the carrier during normal operating conditions.

It is advantageous that the magnet is on the panel and the ferrous member is on the carrier. It is particularly advantageous that the carrier is entirely made from a ferrous material which is attracted to, and can be magnetically attached to the magnet.

It is also advantageous that the magnet or the ferrous member is attached to the panel in a height adjustable manner.

It is further advantageous that the magnet comprises a magnetic strip and a magnet holder, particularly wherein the magnet holder comprises a pair of elongated profile members and the magnetic strip is held between the profile members.

It is also advantageous that the carrier can slide or roll smoothly and easily along a track that supports the carrier and the panel.

### BRIEF DESCRIPTION OF THE DRAWINGS

Further aspects of the invention will be apparent from the detailed description below of particular embodiments and the drawings thereof in which:

FIG. 1 is a perspective view of a sliding screen door, mounted on top and bottom profiles which can be attached near the top and bottom of a door frame;

FIG. 2 is an exploded perspective view of a carrier and a first embodiment of a first embodiment of a magnet and a ferrous member of a releasable connection of the invention for mounting a panel such as the door of FIG. 1 on the top or bottom profiles;

FIG. 3 is a cross-sectional view of a second embodiment of a releasable connection of the invention for mounting a panel such as the door of FIG. 1 on the top or bottom profiles;

FIG. 4 is a cross-sectional view of a third embodiment of a releasable connection of the invention for mounting a panel such as e.g. the door of FIG. 1 on the top or bottom profiles; and

FIG. 5 is a partial perspective view of a fourth embodiment of a ferrous member of a releasable connection of the invention.

### DETAILED DESCRIPTION OF THE PREFERRED EMBODIMENTS

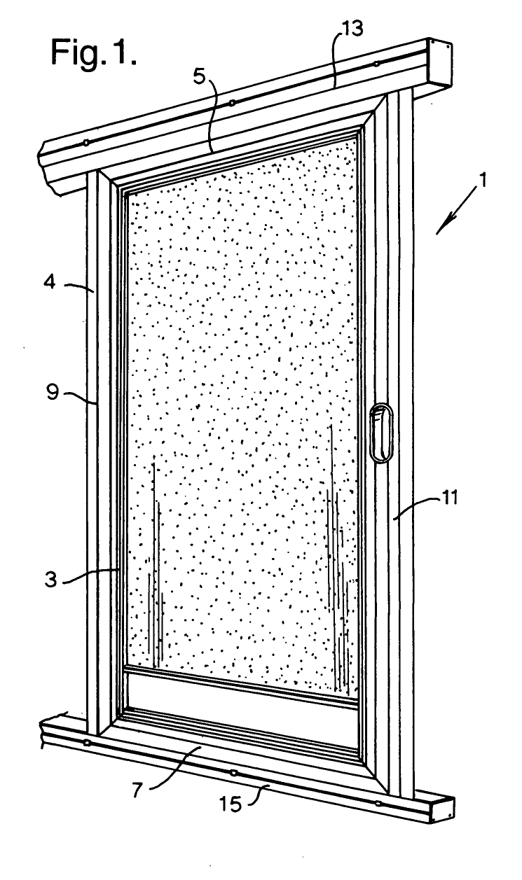

FIG. 1 shows a sliding screen door 1 having a generally rectangular screen 3 fixed in a frame 4 with top, bottom, left and right frame members 5, 7, 9, 11. The door 1 is suspended by its top frame member 5 from a top profile 13. The top profile 13 can be mounted for example parallel to, and above, the top of an architectural opening such as a door frame or the like (not shown), the length of the top profile 13 preferably being longer than the length of the top of the door frame member in order to provide the possibility of sliding the screen door panel in a position coinciding and thus closing the architectural opening and in a position away and thus opening the architectural opening. The bottom frame member 7 of the sliding screen panel is supported by a bottom profile 15 that preferably is mounted parallel to the bottom of an architectural opening such as a door frame or the like and is of equal length to the top profile 13. In this regard, the door 1 is suspended from the top profile 13 and guided by the bottom profile 15, so that door can be moved smoothly and easily along the length of the top and bottom profiles. For this purpose, each profile has a smooth track (not shown) extending horizontally along the length of the profile.

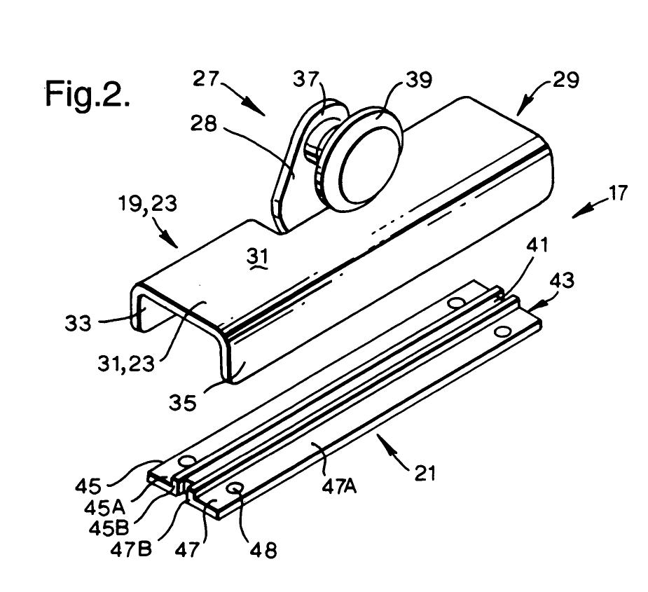

Shown in FIG. 2 is a releasable connection, generally 17, which can be used to attach the top frame member 5 of the door 1 to a carrier 19 which is attached to the top profile 13 in such a way that the carrier can be slid or run along the length of the top profile 13. The releasable connection 17 includes a magnet 21 and a ferrous member 23 which can be attracted to, and magnetically connected to, the magnet 21. The ferrous member 23 is made of a conventional ferrous material, preferably iron or steel. In the releasable connection 17 of FIG. 2, the ferrous member 23 is preferably integral with the carrier 19 in that the carrier or a significant portion thereof is made from a ferrous metal, and the magnet 21 is fixed to the door 1.

As also shown in FIG. 2, the carrier 19 is preferably an elongated profile with a top portion 27 in the form of a top carrier flange 28 and a bottom portion 29 which is in the form of an inverted U-shaped base profile 30. The U-shaped base profile 30 has a top wall 31 and left and right, depending side flanges 33, 35. The top flange 28 is formed from a cut-out and upwardly folded portion of the left side flange 33 and a portion of the top wall 31. The top flange 28 includes an opening 37, to which a conventional runner 39 is rotatably mounted. The distance between the depending side flanges 33, 35 of the carrier 19 is roughly equal to the thickness of the top frame member 5 of the door 1 that is to be attached to the carrier 19. If desired, the side flanges 33, 35 can frictionally engage the top frame member 5, but this is not required. The top wall 31 of the bottom portion 29 of the carrier 19 is the ferrous member 23 of the releasable connection 17 between the carrier and the top profile 13. The top wall 31 is preferably formed completely from a ferrous metal such as steel.

The magnet 21 of the releasable connection 17 is an elongated strip of magnetic material 41 that is attached to a holder 43 which is also shown in FIG. 2. The holder 43 is preferably no longer than the ferrous member 23—that is the ferrous top wall 31 of the bottom portion 29 of the carrier 19. The holder 43 has left and right L-shaped holder members 45, 47 that are preferably of equal length to the magnetic strip 41. The left and right holder members 45, 47 each include a generally horizontal and elongated base flange 45A, 47A and an upstanding holding flange 45B, 47B. The strip 41 of magnetic material is held between, and preferably glued to, the two upstanding flanges 45B, 45B of the holder 43. The holder 43 can be attached to the top wall of the door's top frame member 5 and the bottom wall of the door's bottom frame member 7 in any conventional manner, for example, adhesively, but preferably by threaded fasteners (not shown) extending through holes 48 at the corners of the holder 43.

The number of releasable connections 17 used for attaching a door 1 to the top profiles 13 generally depends on the size and weight of the door 1. Usually more than one carrier 19 is needed to allow for a proper rolling or sliding movement at the top or bottom of a door. For this reason, it is preferred that a plurality of carriers 19 are slidably attached to the top profile 13. In this regard, the rotatable runner 39 of each carrier is positioned in the horizontally-extending track in the top profile 13, so that the roller can roll smoothly and easily along the length of the track. Likewise, it is preferred that a plurality of holders 43 with magnets 21 are fixed to the top of the top frame member 5 of the door 1 and spaced apart along the length thereof.

The magnets 21 are preferably NdFeB (Neodynium-Iron-Boron) magnets. This type of magnet exerts strong magnetic power, so that small magnets can be used which is advantageous in sliding screen door arrangements. Indeed, the stronger the magnet 21, the smaller it can be. The magnets 21 also preferably have a low height, for example between 2 and 3.5 mm.

In use, to install the door 1 to be carried by the top profile 13, the carriers 19 on the top profile are slid or rolled into spaced apart positions along the length of the top profile 13, such that the distance between them and their relative positions are identical to those of the holders 43 with magnets 21 on the top of the top frame member 5 of the door 1.

Then, the door is placed in front of and parallel to the top profile 13 such that the positions of the carriers 19 in the top profile 13, match the positions of the holders 43 on the top frame member 5. The door is now lifted so as to bring its top frame 5 with the magnets 21 into engagement with the ferrous members 23 which are part of the bottom portion 29 of each carrier 19 in the top profile. The door 1 can also be easily removed from the profile 13 by pulling the door away form the carriers on the top profile with a force that exceeds the magnetic force between the magnets 21 and the ferrous members 23.

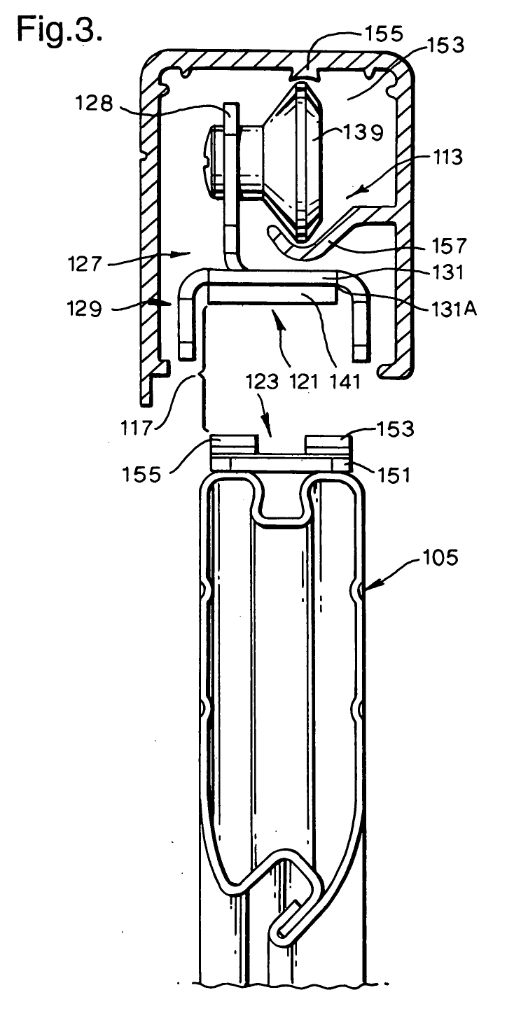

FIG. 3 shows a second embodiment 117 of the releasable connection of the invention which is similar to the releasable connection 17 of FIG. 2 and for which corresponding reference numerals (greater by 100) are used below for describing the same parts or corresponding parts.

As shown in FIG. 3, the releasable connection 117 has a magnet 121 attached to a carrier 119 and a ferrous member 123 attached to the top frame member 105 of a door 101. The ferrous member 123 is in the shape of a mounting plate 151 that is fixed to the top frame member 105 by threaded fasteners (not shown). The magnet 121 is an elongated strip 141 that is attached to the bottom surface 131A of the top wall 131 of the bottom portion 129 of the carrier 119. Preferably the carrier 119 is made of a ferrous metal, but if not, the magnet 121 can be attached to the carrier by a suitable holder, threaded fasteners or by an adhesive.

The mounting plate 151 of the ferrous member 123 on the top of the top door frame member 105, preferably has locater flanges 153, 155 that are resilient and can snap over the rims of the magnetic strip 141 for more easily positioning the magnetic strip on the mounting plate.

As also shown in FIG. 3, a smooth track 153 extends horizontally along the length of the top profile 113. The track 153 has an upper concave downwardly race 155 and a lower concave upwardly race 157. A rotatable runner 139 can be rolled along the track 153 between the upper and lower races 155, 157.

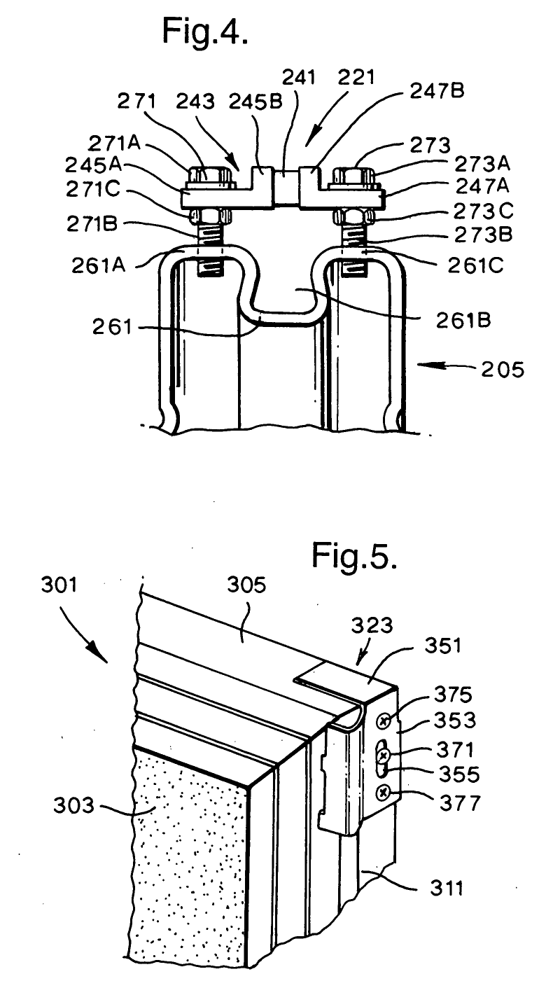

FIG. 4 shows a third embodiment 217 of the releasable connection of the invention which is similar to the releasable connection 17 of FIG. 2 and for which corresponding reference numerals (greater by 200) are used below for describing the same parts or corresponding parts.

As shown in FIG. 4, a top frame member 205 of a door 201 has a top wall 261 that is bent and roll-formed into a desired “M” cross-sectional shape. In this regard, the top wall 261 has across section with a left top portion 261A, a channel 261B and a right top portion 261C. Adjustably fixed to a portion of the top wall 261 is a holder 243 with a magnet 221 that is an elongated strip of magnetic material 241.

The holder 243 has a pair of left and right L-shaped holder members 245, 247 that are of equal length to the magnet strip 241. The holder members 245, 247 each include a generally horizontal and elongated base flange 245A, 247A and an upstanding holding flange 245B, 247B. The base flanges 245A, 247A are adjustably connected to the top portions 261A, 261C of the top wall 261 of the top frame member 205 by threaded bolts 271, 273. The bolts each include a head 271A, 273A, a stem 271B, 273B and a locking nut 271C, 273C.

When the magnet(s) 221 on the holder(s) 243 on the door 201 are attached to the ferrous member(s) on the carrier(s) attached to the top profile, the effective height of the door relative to the top profile can be assessed and if needed it can be adjusted. This can be done by turning the bolts 271, 273 to screw them further down and into, or up and out of, the top wall 261, and subsequently locking the height of the bolts with their locking nuts. Thereby, the height of the holder(s) 243 and the magnet(s) 221 above the top wall 261 of the top frame member 205 can be changed. This feature is often needed to counteract, for example, slanted door frames, in which the door 201 would also have to be slanted. Otherwise, there would be a height difference between the door and the door frame either their left or right side. This feature also is needed to correct the slant of an upper profile that was not perfectly mounted in a door frame.

The fact that the some of the bolts 271, 273 can only be reached when the door 201 is detached from the carrier(s) is not a problem. When the door is hung from the top profile, the need for the height correction of the door can be best assessed. Subsequently, the door can be easily dismounted from the top profile and the height of the holder 243 above the top frame member 205 can be adjusted, and then, the door can than be hung again from the top profile. If needed, this process can be repeated.

FIG. 5 shows a fourth embodiment 323 of the ferrous member of the releasable connection of the invention which is similar to the ferrous member 23 of FIG. 2 and for which corresponding reference numerals (greater by 300) are used below for describing the same parts or corresponding parts.

As shown in FIG. 5, the ferrous member 323 is in the form of a ferrous mounting plate 351 that is mounted on a top frame member 305 of a door 301 and can be magnetically attracted to, and held by, a magnet (not shown) attached to carrier member (also not shown) which can slide or run along a top profile (further not shown).

A downwardly-extending flange 353 of the mounting plate 351 is adjustably fixed to a right frame member 311 of the door 301. For this purpose, a threaded fastener 371 extends leftwardly through a vertically-elongated hole 355 in the mounting plate flange 353. The flange 353 is preferably integrally formed with the mounting plate 351. The threaded fastener 371 and the vertically-elongated hole 355 can be used to adjust the height of the door during its installation. Then, the door can be fixed by providing the threaded fasteners 375, 377 extending leftward through holes in the flange.

The sliding panels of this invention have been described above as being suspended from top profiles, and bottom profiles have been described as guiding the panels and preventing them from swaying in a direction perpendicular to the tracks of the top profiles. However, bottom profiles are not always needed, for example with vertical venetian blind panels. Moreover, sliding panels of this invention could be supported by their bottom frame members from bottom profiles and top profiles could simply guide the panels' top frame members.

This invention is, of course, not limited to the above-described embodiments which may be modified without departing from the scope of the invention or sacrificing all of its advantages. In this regard, the terms in the foregoing description and the following claims, such as “left”, “right”, “upper”, “lower”, “top” and “bottom”, have been used only as relative terms to describe the relationships of the various elements of the releasable connection of the invention for a vertically-extending sliding panel, such as a vertical venetian blind panel, a wall hanging, a solid door or a screen door, which is provided at the top or upper edge and optionally also at the bottom or lower edge of the panel and includes means that can slide or roll smoothly and easily along a track that supports the panel.

For example, other than threaded fasteners can be used for fixing the magnet 21, 121, etc. to the holder 43, 243, etc., such as adhesives or the like. Also, the magnet 21, 121, etc. can be a magnetic strip in a steel holder, and the connection between the magnet and the holder 43, 243, etc. can be adhesive. The steel holder can be of two pieces, with the magnet strip between the two pieces or a strip of a plurality of magnetic pieces can be in the same holder. Furthermore, other sliding panels, besides screen doors, such as solid doors, vertical venetian blind panels and wide blind panels, can be releasably connected in accordance with this invention.

We claim:

1. A sliding panel which is releasably connected at its top or upper edge and/or at its bottom or lower edge to a carrier that supports the panel; wherein the means for releasably connecting the panel and the carrier comprises a magnet and a ferrous member which is attracted to, and can be magnetically attached to, the magnet; and wherein the magnet is on one of either the carrier or the panel and the ferrous member is on the other of the carrier or panel.

2. The panel of claim 1 wherein the magnet is on the panel and the ferrous member is on the carrier.

3. The panel of claim 2 wherein the ferrous member is an integral part of the carrier.

4. The panel of claim 3 wherein the carrier is entirely made from a ferrous material which is attracted to, and can be magnetically attached to, the magnet.

5. The panel of claim 1 wherein the magnet or the ferrous member is attached to the panel in a height adjustable manner.

6. The panel of claim 5 wherein height adjustability is provided by at least one threaded bolt that fixes the magnet or the ferrous member to the panel.

7. The panel of claim 6 wherein the threaded bolt fixes a horizontal base for a holder for the magnet to the panel.

8. The panel of claim 7 wherein the threaded bolt comprises a locking nut between the horizontal base of the holder and the panel.

9. The panel of claim 1 wherein the magnet comprises a magnetic strip and a magnet holder.

10. The panel of claim 9 wherein the magnet holder comprises a pair of elongated profile members and the magnetic strip is held between the profile members.

11. The panel of claim 1 wherein the means for releasably connecting the panel and the carrier comprises a plurality of carriers, magnets and ferrous members.

12. The panel of claim 1 wherein each carrier can slide or roll smoothly and easily along a track that supports the carrier and the panel.

13. The panel of claim 1 which is releasably connected at its top or upper edge to the carrier.

14. The panel of claim 13 wherein its top or upper edge is releasably connected to an upper plurality of carriers which can slide or roll smoothly and easily along an upper track that supports the carriers and the panel.

15. The panel of claim 1 wherein the magnet is a Neodynium-Iron-Boron magnet.

16. The panel of claim 1 wherein the magnet is on the carrier and the ferrous member is on the panel.

17. The panel of claim 16 wherein the ferrous member is attached to the panel in a height adjustable manner.

18. The panel of claim 17 wherein height adjustability is provided by at least one threaded bolt that fixes the ferrous member to the panel.

19. The panel of claim 16 wherein the magnet comprises a magnetic strip and a magnet holder.

20. The panel of claim 19 wherein the magnet holder comprises a pair of elongated profile members and the magnetic strip is held between the profile members.
